(19) United States
(12) Patent Application Publication
(10) Pub. No.: US 2024/0199421 A1
(43) Pub. Date: Jun. 20, 2024

(54) METHOD FOR PREPARING ALUMINUM NITRIDE POWDER BASED ON ALUMINUM METAL

(71) Applicant: NATIONAL CHUNG SHAN INSTITUTE OF SCIENCE AND TECHNOLOGY, Taoyuan City (TW)

(72) Inventors: JIAN-LONG RUAN, Taoyuan City (TW); CHENG-HUNG SHIH, Taoyuan City (TW)

(21) Appl. No.: 18/081,711

(22) Filed: Dec. 15, 2022

(51) Int. Cl. C22C 1/051

(52) U.S. Cl. CPC C22C 1/051

(57) ABSTRACT

A method for preparing aluminum nitride powder, comprising: (A) providing an aluminum metal powder and a carbon source, and mixing the aluminum metal powder and the carbon source to form a mixed powder; (B) performing a medium-low-temperature nitriding reaction on the mixed powder to form a partially nitrided aluminum nitride powder containing an intermediate aluminum carbide phase; (C) subjecting the partially nitrided aluminum nitride powder to a high-temperature nitriding reaction to remove the intermediate aluminum carbide phase and form a fully nitrided aluminum nitride powder; and (D) decarbonizing the fully nitrided aluminum nitride powder in the atmosphere to form a high-purity aluminum nitride powder. Compared with the direct nitriding method of aluminum powder, although additionally introduces the carbon mixing and decarbonizing steps, the subsequent grinding steps can also be omitted, thereby avoiding the introduction of redundant impurities and improving the purity of the output aluminum nitride powder.

### BACKGROUND OF THE INVENTION

### 1. Field of the Invention

The present disclosure relates to a method for preparing aluminum nitride powder, and in particular to a method for preparing aluminum nitride powder based on aluminum metal.

### 2. Description of the Related Art

Aluminum nitride (AlN) is a new type of electronic ceramic material. Due to its excellent thermal conductivity and electrical insulation properties, it has become one of the most popular and advanced materials. Its special physical properties include: high thermal conductivity, high resistivity, low dielectric constant, low thermal expansion coefficient, good electrical resistance, good mechanical strength, high chemical stability, non-toxic, etc. Aluminum nitride can be applied to electronic ceramic substrates, packaging materials for electronic component, anti-corrosion components, additives with high thermal conductivity and other different application fields.

Aluminum nitride belongs to the wurtzite structure of the hexagonal crystal system, and its atoms are bonded by strong covalent bonds arranged in tetrahedrons, so it has a high melting point and good heat transfer performance It is one of the few non-metallic solid with high thermal conductivity and has a theoretical density of 3.26 g/cm³. In addition, because aluminum nitride meets the following four characteristics: (1) low atomic weight; (2) strong atomic bonding; (3) simple crystal structure; and (4) high harmonicity of lattice oscillation, so its theoretical value of thermal conductivity can reach 320 W/mK. The thermal conductivity of commercially available aluminum nitride products is between 170˜230 W/mK. High-purity aluminum nitride is colorless and has the ability to transmit light, but its properties are easily affected by chemical purity and density. Since aluminum nitride has a strong affinity for oxygen atoms, during the process, part of oxygen will dissolve into the aluminum nitride lattice to form impurity defects, making its thermal conductivity worse. This is because the existence of defects, such as impurities, in the lattice will cause the scattering of phonons, which will significantly reduce the thermal conductivity. In addition, aluminum nitride with poor density also has low thermal conductivity.

Currently, the preparation method of aluminum nitride powder is mainly divided into three methods, including direct nitriding method, combustion synthesis method and carbothermal reduction method:
1. Direct nitriding method: Heating the aluminum powder in nitrogen, and directly nitriding the aluminum powder into aluminum nitride powder, of which the reaction formula is as follows.

2Al₍ₛ₎+N_{2(g)}→2AlN₍ₛ₎

Al and N start to react at 500° C., and at 500˜600° C., the oxide film on the surface of the aluminum powder particles generates volatile low-valent oxides and be removed through reaction. Since the nitride film gradually formed on the particle surface will make it difficult for nitrogen to penetrate further, and the nitriding speed will slow down, so secondary nitriding must be carried out to improve the nitriding efficiency. That is, the primary nitriding is held at 800ºC for one hour, and after the product is ball milled, the secondary nitriding is carried out at 1200° C., so that uniform aluminum nitride powder can be prepared.
2. Combustion synthesis method: After the aluminum powder is ignited by an external heat source under high pressure, the high chemical reaction heat generated by the reaction between Al and N keeps the reaction spontaneously until the aluminum powder is completely converted into aluminum nitride. The preparation of aluminum nitride powder by combustion synthesis method is essentially the direct nitriding of aluminum, so the reaction formula is still

2Al₍ₛ₎+N_{2(g)}→2AlN₍ₛ₎

The aluminum nitride powder prepared by this method is not like the direct nitriding method that needs to be nitrided at a temperature higher than 1000° C. for a long time, and does not require an external heat source except for ignition, so it has less energy consumption, low cost, and high production efficiency. However, in the process of combustion synthesis, like the direct nitriding method, due to the low melting point of aluminum, the molten aluminum is prone to agglomeration at high temperature of the combustion synthesis reaction, which hinders the penetration of nitrogen into the powder, making it difficult for the aluminum powder to be completely nitrided. Therefore, the reaction product needs multiple pulverization and nitriding treatments.
3. Carbothermal reduction method: Ultrafine alumina powder and high-purity carbon black are used as starting materials. After ball milling and mixing, alumina is reduced with carbon black at 1400˜1800° C. in a flowing nitrogen atmosphere. The reduced aluminum reacts with nitrogen to form aluminum nitride in a flowing state, and the reaction equation is as follows.

Al₂O₃₍ₛ₎+3C₍ₛ₎+N_{2(g)}→2AlN₍ₛ₎+3CO

The carbothermal reduction reaction requires a molar ratio of alumina to carbon of 1:3, but more carbon is required to completely convert alumina. Adding an appropriate excess of carbon can not only speed up the reaction rate, but also improve the conversion efficiency of alumina powder, thereby obtaining aluminum nitride powder with uniform particle size. However, this method also has disadvantages, that is, excess carbon must be decarbonized in dry air at 600-900° C. after the reaction is complete. Although this method requires secondary carbon removal, which is costly, the omission of subsequent pulverization and grinding steps enables the carbothermal reduction method to prepare aluminum nitride powder with higher purity.

The disclosure patent CN1544316A discloses a method for preparing high-performance aluminum nitride powder by combustion synthesis method, which adopts aluminum powder and aluminum nitride thinner to mix by weight ratio of 1˜3 to 1˜7, then adds 0.5˜2.5 wt % NH₄F or NH₄Cl additive, uses absolute ethanol as the medium, carries out ball milling and mixing for 10-12 hours, and then performs the drying procedure. The dried powder is put into the synthesis reactor, which is then vacuumized and filled with nitrogen gas to 8˜10 MPa, and then the igniter is ignited to trigger the self-propagating combustion reaction of aluminum powder for synthesizing aluminum nitride powder. The disclosure patent CN102531611B discloses a method for preparing aluminum nitride, which uniformly mixes aluminum powder and a surface modifier to form a reactant. The surface modifier is at least one selected from the group consisting of aluminum hydroxide, aluminum nitrate, magnesium hydroxide and calcium hydroxide. Further, based on the total weight of the reactant, the surface modifier is 0.1-30%. Afterwards, the reactant is placed in a container, and the reactant in the container is exposed to a nitrogen-containing gas (with a gas pressure of 0.1-30 atmospheric pressure) and heated to a temperature above 660° C. to burn the reactant. During the heating process, the surface modifier reacts with the aluminum powder to form a ceramic layer on the surface of the aluminum powder to prevent the agglomeration of the aluminum powder due to high-temperature melting, and the aluminum powder undergoes a combustion synthesis reaction with the nitrogen-containing gas due to combustion, thereby forming aluminum nitride.

The disclosure patent CN106744740A discloses a method for preparing aluminum nitride powder. The method fully mixes aluminum powder and 2% to 20% aluminum nitride additive, which are put into a sintering furnace, heated to 500-800° C. at a rate of 3-5° C./min under N₂ and H₂ mixed atmosphere, kept at the temperature for 2-6 hours, then cooled down to 300° C. at a rate of 3-7ºC/min, and then cooled naturally to room temperature to obtain a primary sintered product. After the primary sintered product is pulverized, flux is added, followed by putting into the sintering furnace, heating to 800-1100° C. at a rate of 5˜10° C./min under N₂ and H₂ mixed atmosphere, keeping the temperature for 6˜9 hours, cooling down to 300° C. at a rate of 3-7° C./min, and cooling naturally to room temperature to obtain secondary sintered products, which are pulverized and classified to obtain aluminum nitride powder. The flux is a mixture of NH₄HCO₃ and AlCl₃, of which the mass ratio is 1:2, and the amount of flux added is ½˜¼ of the aluminum nitride additive. The disclosure patent TWI496736B discloses a manufacturing method of spherical aluminum nitride powder, which reduces and nitrides a mixture of 100 parts by mass of alumina or hydrated alumina, 0.5-30 parts by mass of rare earth metal compounds, and 38-46 parts by mass of carbon powder in a nitrogen-containing atmosphere at a temperature of 1620˜1900° C. for more than 2 hours, and then decarburize with an oxidizing gas. The oxidizing gas is preferably air, and the decarburization treatment temperature is 500-900° C., so as to produce spherical aluminum nitride powder.

The common methods for synthesizing aluminum nitride powder are mainly direct nitriding method, combustion synthesis method and carbothermal reduction method. The advantages of the direct nitriding method are low cost, wide source of raw materials, low equipment cost and simple process, but the nitriding reaction process is not easy to control, the stability of product quality is poor, the resulting product is easy to agglomerate, and subsequent grinding and pulverizing steps are required. Accordingly, the preparation cycle will be prolonged, the production cost will be increased, and impurities will be easily brought in during the grinding and pulverizing process, which will affect the purity of the aluminum nitride powder. The combustion synthesis method mainly uses the high chemical reaction heat generated by the reaction of aluminum and nitrogen to make the reaction proceed spontaneously, without the need for an external heat source, with low energy consumption and high production efficiency. However, this method needs to be carried out under high pressure, which requires high equipment performance, and the spontaneous reaction process is difficult to control. At the same time, under the high temperature of the combustion synthesis reaction, the molten aluminum is prone to agglomeration, so the generated product also needs to be ground and pulverized, which is extremely unfavorable for production cost and cycle control and the synthetic purity of aluminum nitride powder. The carbothermal reduction method has the advantages of wide source of raw materials, high purity of synthesized powder, stable performance, uniform distribution of powder particle size, and not easy to agglomerate, etc., and is an ideal method for industrial production of aluminum nitride powder. However, this method has high requirements on the quality of the starting raw materials alumina and carbon black, the raw materials are difficult to mix uniformly, the reaction temperature is high, and the synthesis time is long. At the same time, the excess carbon needs to be decarbonized after the reaction, so the process is more complicated.

In order to solve the above problems and in view of the lacks of known technology, the applicant of the present application provides a method for preparing aluminum nitride powder based on aluminum metal, which uses aluminum metal as the starting material, refers to the conception of carbothermal reduction method, improves direct nitriding process technology, adds the step design of aluminum powder mixing with carbon, forms the aluminum carbide intermediate phase to avoid the problem of high-temperature melting and agglomeration of aluminum powder, omits subsequent grinding and pulverizing operations, and reduces the nitriding reaction temperature and time to prepare high-purity aluminum nitride powder. The following is a brief description of the present application.

### BRIEF SUMMARY OF THE INVENTION

The present disclosure relates to a method for preparing aluminum nitride powder and, in particular, to a method for preparing aluminum nitride powder based on aluminum metal. The present disclosure combines the steps of carbon mixing with aluminum powder, medium-low-temperature nitriding, high-temperature nitriding and atmospheric decarburization to provide a method for preparing aluminum nitride powder that is different from the conventional method of directly nitriding aluminum powder. By the introduction of the carbon source, the intermediate aluminum carbide phase is formed on the surface of the aluminum powder to avoid the melting and agglomeration phenomenon appeared between the aluminum powder. Accordingly, the aluminum powder can maintain gaps between each other for the nitriding atmosphere to fully circulate and react with the aluminum powder, thereby improving the nitriding efficiency, eliminating the subsequent grinding and pulverizing steps due to the melting and agglomeration of aluminum powder, reducing the introduction of impurities and improving the purity of the output aluminum nitride powder.

According to the conception of the present disclosure, a method for preparing aluminum nitride powder based on aluminum metal is provided. The method includes the steps of: (A) providing an aluminum metal powder and a carbon source, and uniformly mixing the aluminum metal powder and the carbon source to form a mixed powder; (B) performing a medium-low-temperature nitriding reaction on the mixed powder in a nitrogen-containing gas atmosphere to form a partially nitrided aluminum nitride powder containing an intermediate aluminum carbide phase; (C) subjecting the partially nitrided aluminum nitride powder to a high-temperature nitriding reaction in a nitrogen-containing gas atmosphere to remove the intermediate aluminum carbide phase and form a fully nitrided aluminum nitride powder; and (D) decarbonizing the fully nitrided aluminum nitride powder in the atmosphere to form a high-purity aluminum nitride powder.

The aluminum metal powder of step (A) described above has a purity of more than 99% and an average particle size of 10-100 μm. The carbon source is selected from graphite, carbon black and activated carbon and has a purity of more than 99%, an average particle size of less than 30 μm and a BET specific surface area of 0.1˜500 m²/g. The uniformly mixing is a dry mixing or wet mixing process, but the wet mixing process further needs a drying procedure before obtaining a mixed powder material. The mixing weight ratio of the aluminum metal powder and the carbon source is 1:0.3˜1.0.

The temperature of the medium-low-temperature nitriding reaction of step (B) described above is 700° ° C.˜1200° C. and the reaction time of the medium-low-temperature nitriding reaction of step (B) is 1˜8 hours.

The nitrogen-containing gas of step (B) described above is at least one selected from the group consisting of ammonia, nitrogen, air and nitrogen-hydrogen mixed gas.

The temperature of the high-temperature nitriding reaction of step (C) described above is 1200° ° C.˜1800° C. and the reaction time of the high-temperature nitriding reaction of step (C) is 2˜20 hours.

The nitrogen-containing gas of step (C) described above is at least one selected from the group consisting of ammonia, nitrogen and nitrogen-hydrogen mixed gas.

The decarbonizing temperature of step (D) described above is 500° ° C.˜900° C., and the decarbonizing time of step (D) is 10˜50 hours.

The present disclosure uses aluminum metal as a starting material with reference to the conception of carbothermal reduction method, improves the direct nitriding process technology, adds aluminum powder and carbon mixing step design, and introduces a two-stage nitriding heat treatment procedure, avoids the problem of high-temperature melting and agglomeration of aluminum powder by the formation of intermediate aluminum carbide phase and reduces the nitriding reaction temperature and time simultaneously, thereby preparing high-purity aluminum nitride powder.

The technology of the present disclosure retains the advantages of the carbothermal reduction method, improves the shortcoming of the direct nitriding method and provides a method for preparing aluminum nitride powder that is different from the conventional method of directly nitriding aluminum powder, which avoids the aluminum powder melting and agglomeration problem caused by the direct nitriding method. Compared with the direct nitriding method, although the present disclosure additionally introduces the carbon mixing and decarbonizing steps, the subsequent grinding steps can also be omitted, thereby avoiding the introduction of redundant impurities and keeping the advantage of relatively high purity of the aluminum nitride powder produced by the carbothermal reduction method.

The above summary and the following detailed description and accompanying drawings are all for further illustrating the ways, means and effects that the present disclosure takes to achieve the intended purpose. Other purposes and advantages of the present disclosure will be described in the subsequent description and drawings.

### BRIEF DESCRIPTION OF THE DRAWINGS

FIG. 1 is a flow chart of a method for preparing aluminum nitride powder based on aluminum metal of the present disclosure.

FIG. 2 shows the comparison of the aluminum nitride powder X-ray diffraction patterns at different stages after the medium-low-temperature nitriding and high-temperature nitriding according to the embodiments of the present disclosure.

FIG. 3 is X-ray diffraction pattern of the aluminum nitride powder after the medium-low-temperature nitriding, high-temperature nitriding and atmospheric decarburization according to the embodiment of the present disclosure.

### DETAILED DESCRIPTION OF THE INVENTION

The following specific examples illustrate the implementation of the present disclosure, and those skilled in the art can easily understand the advantages and effects of the present disclosure from the contents disclosed in the description.

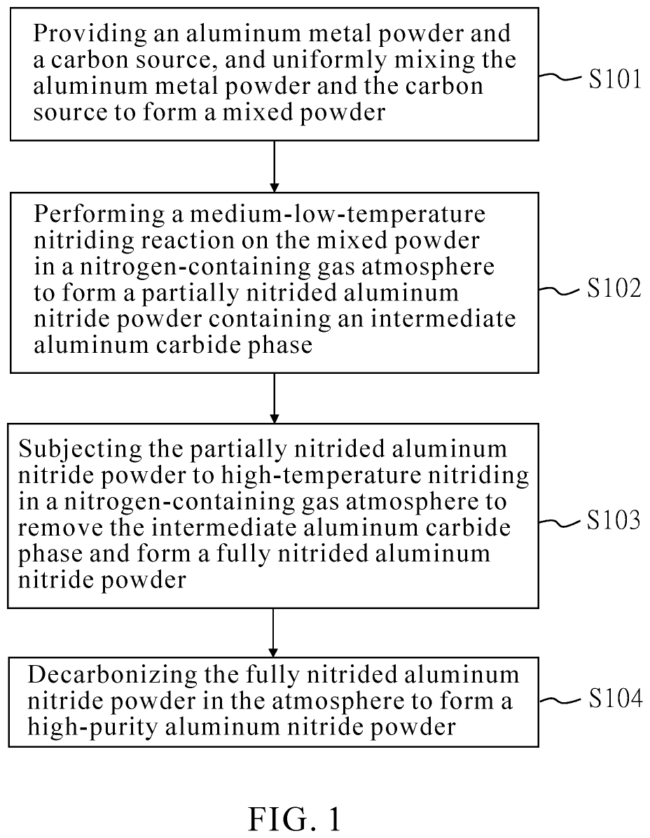

With reference to FIG. 1, which is a flow chart of a method for preparing aluminum nitride powder based on aluminum metal of the present disclosure, and the steps include: (A) providing an aluminum metal powder and a carbon source, and uniformly mixing the aluminum metal powder and the carbon source to form a mixed powder S101; (B) performing a medium-low-temperature nitriding reaction on the mixed powder in a nitrogen-containing gas atmosphere to form a partially nitrided aluminum nitride powder containing an intermediate aluminum carbide phase S102; (C) subjecting the partially nitrided aluminum nitride powder to a high-temperature nitriding reaction in a nitrogen-containing gas atmosphere to remove the intermediate aluminum carbide phase and form a fully nitrided aluminum nitride powder S103; and (D) decarbonizing the fully nitrided aluminum nitride powder in the atmosphere to form a high-purity aluminum nitride powder S104.

The aluminum metal powder described in step S101 is preferably a granulated aluminum powder with a purity of more than 99% and an average particle size of 30 to 80 μm in this embodiment. The carbon source described in step S101 is preferably carbon black in the present embodiment, its purity is more than 99%, its average particle diameter is less than 30 μm, and its BET specific surface area is 0.1˜100 m²/g. The mixed powder material described in step S101 preferably has a mixing weight ratio of aluminum powder to carbon black of 1:0.3˜0.5 in this embodiment.

In the mixed powder, if the amount of carbon source used is too much, the above-mentioned aluminum source (aluminum powder) will exist in the mixture in a loose state, and when it is subjected to heat treatment for nitriding, the particles of aluminum nitride will not be able to fully grow and affects the crystallinity. Further, the use of too much carbon source will increase the difficulty of the subsequent decarbonizing step. If the amount of carbon source used is too small, the aluminum source will agglomerate violently, and the obtained aluminum nitride powder will contain most coarse particles or form agglomerates, which need to be further ground and pulverized.

The temperature of the medium-low-temperature nitriding reaction described in step S102 is preferably 900˜1100° C. in this embodiment, and the reaction time is preferably 2˜4 hours. The nitrogen-containing gas described in step S102 is preferably nitrogen.

The temperature of the high-temperature nitriding reaction described in step S103 is preferably 1400˜1600° C. in this embodiment, and the reaction time is preferably 4˜8 hours. The nitrogen-containing gas described in step S103 is preferably nitrogen.

The decarbonizing treatment described in step S104 is to oxidize and remove carbon, and uses an oxidizing gas to implement. As to the oxidizing gas, all the gas that can remove carbon, such as air, oxygen, etc., can be used without any limitation. However, considering the economy and the oxygen concentration of the output aluminum nitride, the oxidizing gas preferably uses air (atmospheric atmosphere) in this embodiment. In addition, considering the efficiency of decarburization and the excessive oxidation of the aluminum nitride surface, the decarbonizing temperature is preferably 600-750° C. and the decarbonizing time is preferably 20-30 hours in this embodiment.

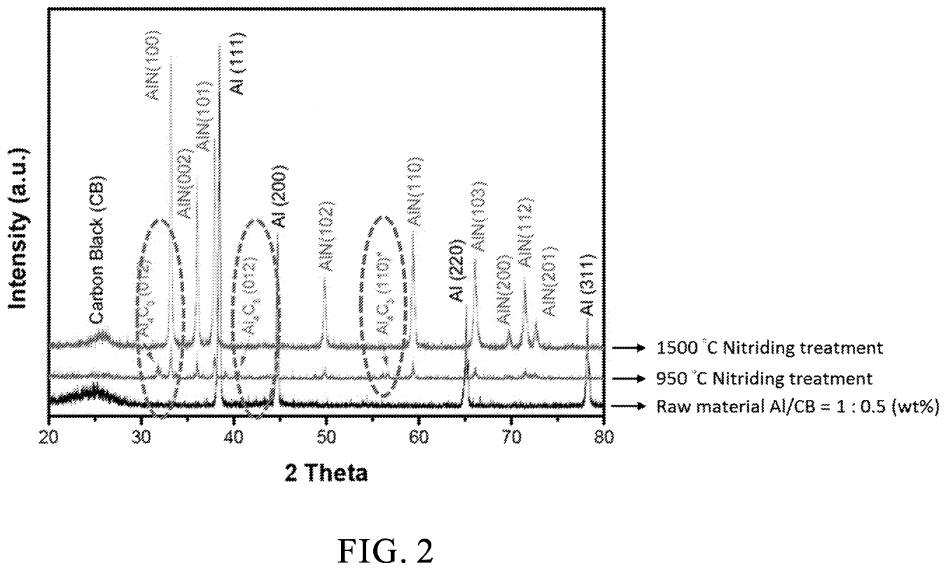

With reference to FIG. 2, which shows the comparison of the aluminum nitride powder X-ray diffraction patterns at different stages after the medium-low-temperature nitriding and high-temperature nitriding according to the embodiments of the present disclosure. The mixture of aluminum powder and carbon black with a weight ratio of 1:0.5 is used as the starting powder, which is subject to medium-low-temperature nitriding at 950° C. for a reaction time of 2 hours, followed by high-temperature nitriding at 1500° C. for a reaction time of 4 hours. The comparison of the powder X-ray diffraction patterns of the above-mentioned products in each stage is shown in FIG. 2. After nitriding at medium to low temperature, a partially nitrided aluminum nitride powder containing intermediate aluminum carbide (Al₄C₃) phase is formed. After nitriding at high temperature, the intermediate aluminum carbide phase is removed to form a completely nitrided aluminum nitride powder, but the powder still contains excess carbon black.

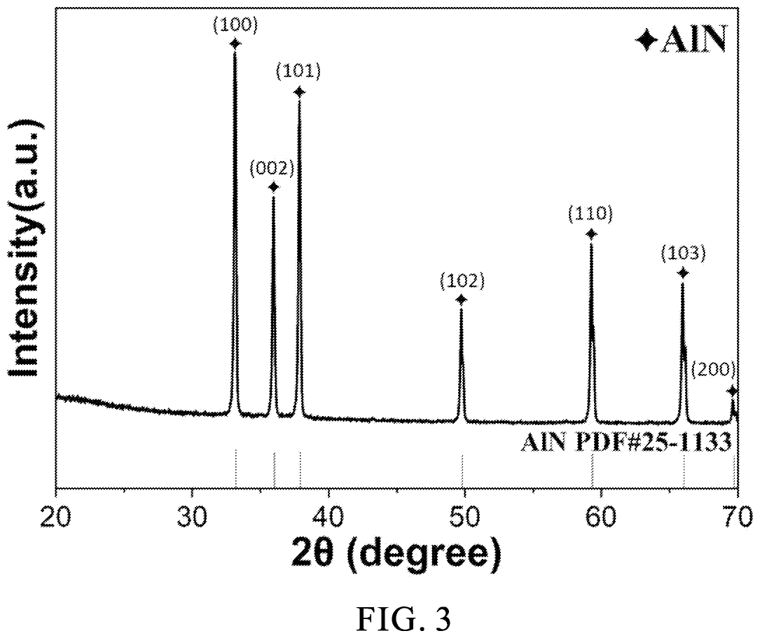

With reference to FIG. 3, which is X-ray diffraction pattern of the aluminum nitride powder after the medium-low-temperature nitriding, high-temperature nitriding and atmospheric decarburization according to the embodiment of the present disclosure. The above-mentioned aluminum nitride powder that has been nitrided at a medium and low temperature and high temperature is subjected to decarburization in an atmospheric atmosphere. The decarbonizing temperature is 600° C., and the decarbonizing time is 30 hours. The X-ray diffraction pattern of the aluminum nitride powder after decarburization is shown in FIG. 3. After decarburization in the atmosphere, the excess carbon black is removed to form the aluminum nitride powder with high purity.

Through the above examples, the method for preparing aluminum nitride powder based on aluminum metal of the present disclosure uses aluminum powder as the starting material, refers to the conception of carbothermal reduction method, improves the direct nitriding process technique, adds the step design of aluminum powder mixing with carbon, and introduces a two-stage heat treatment procedure for nitriding. The medium-low-temperature nitriding at the first stage forms the intermediate aluminum carbide phase on the surface of the aluminum powder to avoid the melting and agglomeration phenomenon appeared between the aluminum powder. Accordingly, the aluminum powder can maintain gaps between each other for the nitriding atmosphere to fully circulate, thereby improving the nitriding efficiency, eliminating the subsequent grinding step due to the melting and agglomeration of aluminum powder and reducing the introduction of impurities. The high-temperature nitriding at the second stage removes the intermediate aluminum carbide phase and further increase the degree of nitriding. Finally, decarburization is performed in atmosphere to remove excess carbon sources in the powder, resulting in aluminum nitride powder with high purity. The present disclosure can also use recycled aluminum powder made from smelting and atomization of waste aluminum targets as starting raw materials to produce aluminum nitride powder with high economic value, strengthens the recycling and regeneration application of waste materials, and promotes the development of circular economy industries.

Compared with the direct nitriding method, although the present disclosure adds the carbon mixing and decarburization steps, which will inevitably increase the cost of the manufacturing process and energy consumption, but the use of cheap recycled raw materials and the processing with value enhancement can improve the overall value of the products. At present, the recycling price of 5N grade waste aluminum target is only NTD 200 NTD/kg. If the waste aluminum target is smelted, atomized and regenerated into high-purity aluminum powder, the regeneration cost is about 1,000 NTD/kg. Further through nitriding with mixed carbon, the production cost of the high-purity aluminum nitride powder is about 1,500 NTD/kg, so the total cost is about 2,700 NTD/kg. On the other hand, the selling price of high-purity aluminum nitride powder is about 5,000 NTD/kg, so there is an economy profit of about 2,300 NTD/kg, which exhibits considerable economic benefits.

The embodiments described above are only illustrative of the characteristics and effects of the present invention and are not intended to limit the scope of the essential technical content of the present invention. Any person familiar with the art can modify and change the above-mentioned embodiments without departing from the spirit and scope of the invention. Therefore, the right protection scope of the present invention should be defined by the appended claims.

What is claimed is:

1. A method for preparing aluminum nitride powder based on aluminum metal, comprising:
(A) providing an aluminum metal powder and a carbon source, and uniformly mixing the aluminum metal powder and the carbon source to form a mixed powder;
(B) performing a medium-low-temperature nitriding reaction on the mixed powder in a nitrogen-containing gas atmosphere to form a partially nitrided aluminum nitride powder containing an intermediate aluminum carbide phase;
(C) subjecting the partially nitrided aluminum nitride powder to a high-temperature nitriding reaction in a nitrogen-containing gas atmosphere to remove the intermediate aluminum carbide phase and form a fully nitrided aluminum nitride powder; and
(D) decarbonizing the fully nitrided aluminum nitride powder in the atmosphere to form a high-purity aluminum nitride powder.

2. The method for preparing aluminum nitride powder based on aluminum metal according to claim 1, wherein the aluminum metal powder of step (A) has a purity of more than 99% and an average particle size of 10-100 μm.

3. The method for preparing aluminum nitride powder based on aluminum metal according to claim 1, wherein the carbon source of step (A) is selected from graphite, carbon black and activated carbon and has a purity of more than 99%, an average particle size of less than 30 μm and a BET specific surface area of 0.1˜500 m²/g.

4. The method for preparing aluminum nitride powder based on aluminum metal according to claim 1, wherein the uniformly mixing of step (A) is a dry mixing or wet ball milling process.

5. The method for preparing aluminum nitride powder based on aluminum metal according to claim 1, wherein a mixing weight ratio of the aluminum metal powder and the carbon source of step (A) is 1:0.3˜1.0.

6. The method for preparing aluminum nitride powder based on aluminum metal according to claim 1, wherein a temperature of the medium-low-temperature nitriding reaction of step (B) is 700° ° C.˜1200° ° C. and a reaction time of the medium-low-temperature nitriding reaction of step (B) is 1˜8 hours.

7. The method for preparing aluminum nitride powder based on aluminum metal according to claim 1, wherein the nitrogen-containing gas of step (B) is at least one selected from the group consisting of ammonia, nitrogen, air and nitrogen-hydrogen mixed gas.

8. The method for preparing aluminum nitride powder based on aluminum metal according to claim 1, wherein a temperature of the high-temperature nitriding reaction of step (C) is 1200° ° C.˜1800° ° C. and a reaction time of the high-temperature nitriding reaction of step (C) is 2˜20 hours.

9. The method for preparing aluminum nitride powder based on aluminum metal according to claim 1, wherein the nitrogen-containing gas of step (C) is at least one selected from the group consisting of ammonia, nitrogen and nitrogen-hydrogen mixed gas.

10. The method for preparing aluminum nitride powder based on aluminum metal according to claim 1, wherein a decarbonizing temperature of step (D) is 500° ° C.˜900° ° C., and a decarbonizing time of step (D) is 10˜50 hours.
